(19) United States
(12) Patent Application Publication
(10) Pub. No.: US 2021/0194301 A1
(43) Pub. Date: Jun. 24, 2021

(54) ROTARY ELECTRICAL MACHINE WITH A RATIO OF DIMENSIONS WHICH MINIMISES THE NOISE

(71) Applicant: Valeo Equipements Electriques Moteur, Creteil Cedex (FR)

(72) Inventors: Rijaniaina Njakasoa Andriamalala, Créteil Cedex (FR); Mamy Rakotovao, Créteil Cedex (FR); Johnny Duarte, Créteil Cedex (FR)

(73) Assignee: Valeo Equipements Electriques Moteur, Creteil Cedex (FR)

(21) Appl. No.: 17/117,590

(22) Filed: Dec. 10, 2020

(30) Foreign Application Priority Data
Dec. 19, 2019 (FR) 1915022

(51) Int. Cl. H02K 1/27

(52) U.S. Cl. CPC H02K 1/2773

(57) ABSTRACT

The invention relates to a rotor (11) for an electrical machine, in particular for a motor vehicle, having an axis of rotation (X), a rotor radius (Rr), a polar step (τ), and including a body (31) comprising a plurality of rotor teeth (40) defining cavities (36) in which permanent magnets (37) are accommodated, each rotor tooth (40) comprising a single lip (41) for radial retention of a permanent magnet, and an assembly of magnetic poles (50), each pole having a curvature in the form of an arc of a circle, the said arc of a circle being defined by a radius of curvature (R_{c}), a centre of curvature (C_{c}), and a polar angle (2αₚ), the said rotor having a ratio (r) between the radius of curvature (R_{c}) and the rotor radius (Rᵣ) contained between 0.52 and 0.63, and a ratio (α) between the polar half-angle (αₚ) and the polar step (τ) contained between 0.62 and 0.80.

The present invention relates to a rotor of a single-lip rotary electrical machine which is used in particular in motor vehicles. It also relates to a rotary electrical machine comprising the rotor according to the present invention.

The invention has a particularly advantageous, but non-exclusive application with high-power electrical machines which can operate in alternator mode and in motor mode.

In a known manner, rotary electrical machines comprise a stator and a rotor integral with the shaft. The rotor can be integral with a driving and/or driven shaft, and can belong to a rotary electrical machine in the form of an alternator, an electrical machine, or a reversible machine which can operate in both modes.

The stator is fitted in a housing which is configured to rotate the shaft, for example by means of roller bearings. The stator comprises a body provided with a plurality of teeth defining notches, and a winding which is inserted in the notches of the stator.

The winding is obtained for example from continuous wires covered with enamel, or from conductive elements in the form of pins which are connected to one another by welding. Alternatively, the phases of the machine are formed from individual coils which are each wound around a stator tooth. The phases, which are connected in the form of a star or a triangle, comprise outputs which are connected to an electrical control module. In addition, the rotor comprises a body formed by a stack of metal plate sheets, which are retained in the form of a set by means of an appropriate securing system. The rotor comprises poles, which are formed for example by permanent magnets accommodated in cavities each delimited by two adjacent rotor teeth.

A certain number of machines according to the prior art, such as synchronous machines with permanent magnets, have optimal performance levels such as the torque and the output, but they also have a problem with noise. A plurality of works have been tested by various means for reduction of the noise, for example by optimising the geometric form of each stator tooth, by working on the form of the magnet wheel, or on the control algorithm.

The objective of the invention is to propose an optimal definition of the rotor, in order to reduce the noise of electromagnetic origin of the machine, without detracting from the performance levels.

For this purpose, the subject of the invention is a rotary electrical machine, in particular for a motor vehicle, having an axis of rotation, a rotor radius, a polar step, and comprising:
a body comprising a plurality of rotor teeth defining cavities in which permanent magnets are accommodated, each rotor tooth comprising a single lip for radial retention of a permanent magnet; and
an assembly of magnetic poles, each pole having a curvature in the form of an arc of a circle, the said arc of a circle being defined by a radius of curvature, a centre of curvature, and a polar angle,
   wherein the rotor has a ratio between the radius of curvature and the rotor radius contained between 0.52 and 0.63, and a ratio between the polar half-angle and the polar step contained between 0.62 and 0.80.

The definition of a ratio of this type makes it possible to obtain an optimum compromise between the torque supplied by the machine, and the corresponding level of torque undulation. The invention thus makes it possible to improve the magnetic and acoustic performance levels of a rotary electrical machine comprising a rotor of this type. In fact, the radius of curvature of the magnetic pole and the polar angle are the two geometric parameters which affect the performance levels of the electrical machine most.

In addition, each rotor tooth comprising a single lip for radial retention of a permanent magnet thus makes it possible, by eliminating one of the retention lips, to reduce the magnetic leakages between the poles of the rotor. This therefore improves the magnetic performance levels of the rotor, which makes it possible to reduce the mass of permanent magnets used, in order to make savings on the cost price of the machine.

Within the context of the present invention, the “polar step” is defined as being equal to 360° divided by the number of poles. “Arc of a circle” designates the osculating arc of a circle of the pole. The centre of this circle is known as the centre of curvature of the curve at the point M, and its radius is the radius of curvature.

In the description and the claims, the terms “outer” and “inner” will be used, as well as the orientations “axial” and “radial” in order, according to the definitions given in the description, to designate elements of the rotor, the stator and/or of the electrical machine. By convention, the “radial” orientation is directed orthogonally to the axial orientation. According to the context, the axial orientation relates to the axis of rotation of the rotor, the stator and/or the electrical machine. The “circumferential” orientation is directed orthogonally to the axial direction and orthogonally to the radial direction. The terms “outer” and “inner” are used to define the relative position of one element in relation to another, in relation to the reference axis, and an element close to the axis is thus classified as inner as opposed to an outer element which is situated radially on the periphery.

In addition, any interval of values which is designated by the expression “between a and b” signifies the field of values going up to b (i.e. including the strict limits a and b).

The radius of curvature and the rotor radius are expressed in millimetres [mm], and the polar half-angle and the polar step are expressed in degrees [° ].

According to other advantageous embodiments, a rotor of this type can have one or a plurality of characteristics alone or in combination.

According to one embodiment, the rotor has a ratio between the radius of curvature and the rotor radius contained between 0.54 and 0.61, and a ratio between the polar half-angle and the polar step contained between 0.64 and 0.78. This ratio makes it possible to reduce the torque undulations even more efficiently, whilst maintaining a very satisfactory level of the mean torque supplied by the machine comprising the rotor according to the present invention. The term “contained” means that the limits of the intervals are included in the interval.

According to one embodiment, each rotor tooth comprises a radially outer surface, the said surface being defined by the said arc of a circle with a centre of curvature, with one of the two ends comprising the said lip.

According to one embodiment, the two ends of a radially outer surface of a rotor tooth have a curvature different from the curvature of the arc of a circle with a centre of curvature of this same surface. In other words, the two ends, with one of the two ends comprising the lip, are not inscribed in the circle of curvature defining the arc of a circle of each magnetic pole.

As a variant, the two ends of a radially outer surface of a rotor tooth are not inscribed in the circle of curvature defining the arc of a circle of each magnetic pole. The ends and the arc of a circle of each pole thus have the same curvature.

According to one embodiment, the two ends of a single radially outer surface of the rotor tooth are asymmetrical. This is asymmetry (which is also known as dis-symmetry) makes it possible to reduce the torque undulations even more efficiently, whilst maintaining a very satisfactory level of the mean torque supplied by the machine comprising the rotor according to the present invention.

As a variant, the two ends of a single radially outer surface of a rotor tooth are symmetrical.

According to one embodiment, the rotor is of the type with concentration of flux.

According to one embodiment, the rotor comprises added-on strips which are each fitted between a lip and an outer periphery of a corresponding permanent magnet.

According to one embodiment, the permanent magnets are made of rare earth.

According to one embodiment, the rotor is formed by a set of metal plates.

According to one embodiment, the rotor comprises a core provided with a central opening for the passage of a shaft, the said rotor teeth being connected to the said core by one of their ends.

According to another aspect, the invention relates to a rotary electrical machine comprising a rotor as previously defined.

The invention will be better understood by reading the following description and examining the figures which accompany it. These figures are provided purely by way of illustration and in no way limit the invention.

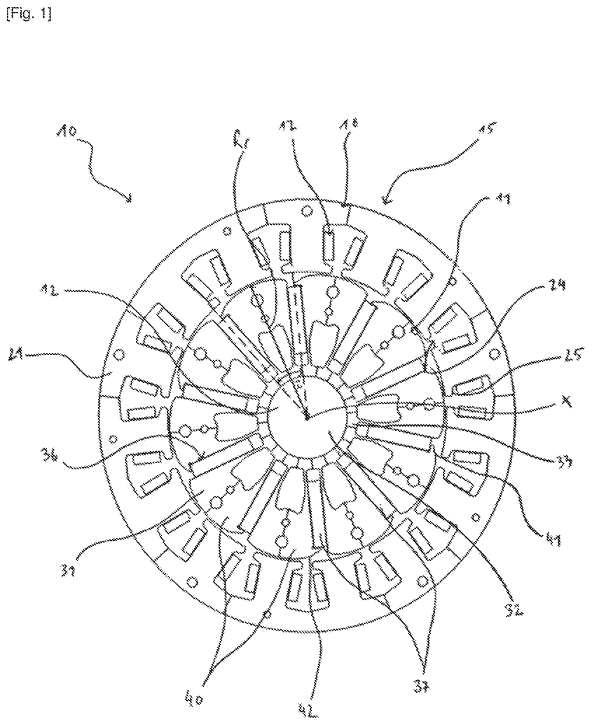

FIG. 1 represents a view in transverse cross-section of the rotary electrical machine according to the present invention.

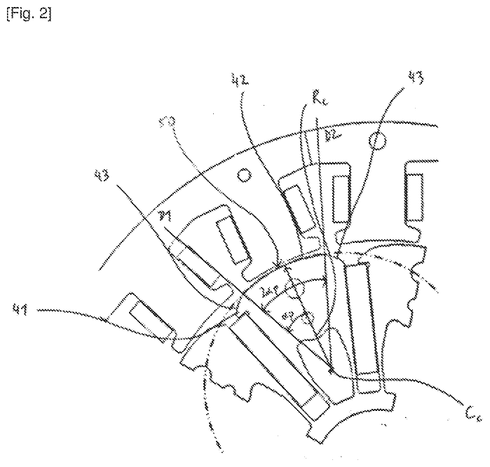

FIG. 2 represents a detailed view in transverse cross-section of a rotor according to a first embodiment.

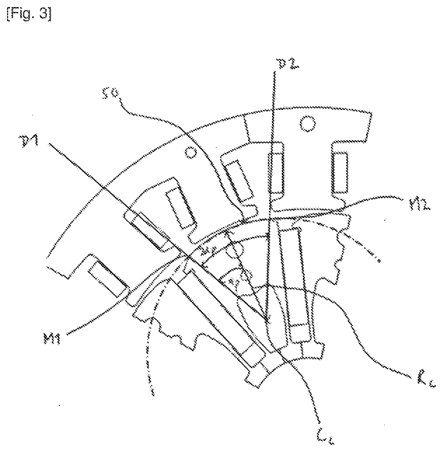

FIG. 3 represents a detailed view in transverse cross-section of a rotor according to a second embodiment.

Elements which are identical, similar or analogous retain the same reference from one figure to another.

FIG. 1 shows a rotary electrical machine 10 comprising a rotor 11 with an axis of rotation X, a rotor radius Rr, a polar step τ, and which is designed to be fitted on a shaft 12. A wound stator 15, which can be polyphase, surrounds the rotor 11 with the presence of an air gap between the outer periphery of the rotor 11 and the inner periphery of the stator 15. This stator 15 is secured on a housing which is configured to rotate the shaft 12 via ball bearings and/or needle bearings.

More specifically, the stator 15 comprises a body 16 and a winding 17. The stator body 16 consists of an axial stack of flat metal plates. The body 16 comprises stator teeth 20 which are distributed angularly regularly on an inner periphery of a yoke 21. These teeth 20 delimit notches 24, such that each notch 24 is delimited by two successive teeth 20. The yoke 21 thus corresponds to the solid outer annular portion of the body 16 which extends between the base of the notches 24 and the outer periphery of the stator 15.

The notches 24 open axially into the axial end faces of the body 16. The notches 24 are also open radially towards the interior of the body 16.

The stator 15 is provided with tooth roots 25 on the side of the free ends of the teeth 20. Each tooth root 25 extends circumferentially on both sides of a corresponding tooth 20. Each tooth root 25 extends circumferentially according to an arc of a circle centred on the axis of rotation X.

In order to obtain the winding 17, a plurality of phases are formed by coils which are each wound around a stator tooth 20. Each coil is formed from an electrically conductive wire covered with a layer of electrically insulating material such as enamel. A coil insulator can be interposed between each coil and the corresponding tooth 20.

In addition, the rotor 11 comprises a body 31 formed by an axial stack of flat metal plates, in order to reduce the Foucault currents. The body 31 is made of ferromagnetic material. The body 31 can be connected in rotation to the shaft 12 of the rotary electrical machine in different ways, for example by forcing of the ribbed shaft 12 into the interior of the central opening 32 of the rotor, which opening is provided in the core 33.

The rotor 11 comprises a plurality of cavities 36, in the interior of which there are positioned permanent magnets 37 forming magnetic poles 50. A cavity 36 can contain a single magnet 37 with a parallelepiped form. As a variant, a cavity 36 can contain a plurality of magnets 37 stacked axially or radially relative to one another. The magnets 37 can have bevelled angles.

The magnets 37 are preferably made of rare earth, in order to maximise the power of the machine 10. As a variant, the magnets 37 can be of a different grade in order to reduce the costs. For example, in each cavity 36, there is association of a magnet made of rare earth and a magnet made of ferrite, which is less powerful but less costly.

The rotor 11 has concentration of flux, i.e. the lateral faces facing one another of the magnets 37 situated in two consecutive cavities have the same polarity.

Each cavity 36 passes through the body 31 from one axial end face to the other, and is open on the side of the outer periphery of the rotor 11. As a variant, the cavities 36 can be blind.

In this case, each cavity 36 is delimited by two adjacent rotor teeth 40 of the rotor 11. The rotor teeth 40 are spaced angularly regularly from one another. The rotor teeth 40 are connected by one of their ends to the core 33 provided with the opening 32.

In order to ensure axial retention of the magnets 37, flanges (not represented) are placed against the axial ends of the rotor body 31. These flanges can also have a function of balancing of the rotor 11.

According to a particular embodiment not represented, it is possible to provide added-on strips which are each fitted between a lip 41 and an outer periphery of a corresponding permanent magnet 37. Each strip is in the form of a small plate made of a material which is less hard than the material of the magnets 37. This can for example be glass fibres embedded in a pre-impregnated plastic material. The strip is flat, rectangular, and has substantially the same dimensions and the same form as the outer circumferential face of the magnet 37, which it covers with its coinciding edges. According to a different embodiment, the dimensions can be different. A layer of adhesive more flexible than the magnet 37 can be interposed between the magnet 37 and the strip.

Within the context of the present invention, each rotor tooth 40 comprises a single lip 41. In the examples considered, the cavity 36 is partly closed at the outer periphery of the rotor by a single lip 41 for radial retention of the magnet. Thus, all the lips 41 extend circumferentially from the same face of a corresponding rotor tooth 40.

In the examples considered, a single lip 41 extends from the left face of each rotor tooth 40. In a variant not represented, a single lip 41 could extend from the right face of each rotor tooth 40.

With reference to FIGS. 2 and 3, each magnetic pole 50 has curvature in the form of an arc of a circle. The arc of a circle corresponds to the common part between the magnetic pole 50 and the osculating circle of this same pole 50 defined by a radius of curvature Rc, a centre of curvature Cc, and a polar angle 2αp. The arc of a circle is thus limited at its two circumferential ends by points M1 and M2, the points M1 and M2 being the final points which are situated both on the osculating circle of the magnetic pole 50 and on the magnetic pole 50.

The polar angle 2αp is thus equal to the angle between two straight lines D1 and D2 each passing via the centre of curvature Cc and an end M1/M2.

Each rotor tooth 40 comprises a radially outer surface 42, situated facing the inner periphery of the stator 15. The surface 42 is thus defined by the said arc of a circle with a centre Cc and two ends 43. In the examples considered, one of the two ends 43 comprises the lip 41.

According to a preferred embodiment, the two ends 43 of a surface 42 have a different curvature from the curvature of the arc of a circle with a centre Cc of this same surface 42. In other words, the radially outer surface of the ends 43 does not have any point situated on the osculating circle of the magnetic pole 50 and comprising the said arc of a circle delimited by the points M1 and M2. This makes it possible to obtain a machine with a variable air gap.

In the rotor shown in FIG. 2, the two ends 43 of a single surface 42 are asymmetrical, whereas in the rotor shown in FIG. 3, the two ends 43 of a single surface 42 are symmetrical. The symmetry corresponds to an outer surface profile which is symmetrical relative to a median straight line of the pole.

In the context of the present invention, the rotor has a ratio r between the radius of curvature Rc and the rotor radius Rr contained between 0.5 and 0.7, and a ratio α between the polar half-angle αp and the polar step τ contained between 0.6 and 0.8.

A description will be provided hereinafter of how these ratios have been determined. The objective is to attempt to minimise the noise by means of a process of optimisation of the radius of curvature and the polar half-angle, but whilst maintaining the magnetic performance levels required by the specifications.

A conventional machine with a magnet in the form of an I comprising two lips per pole (also known as bi-lip) with magnets made of neodymium, iron and boron (Nd2Fe14B), with 10 poles, 15 notches, a concentrated winding, a package height of 217 mm and a stator outer diameter of 93 mm was used as a reference machine. An optimal combination of the performance levels was thus obtained on this machine as far as the torque and noise are concerned by seeking the optimal combination of the radius of curvature Rc and the polar half-angle αp, with values respectively of 18 mm and 22°. By relating these values to the rotor radius Rr and the polar step τ, these optimal values become r=0.57 and α=0.61.

The reference machine was then modified according to a machine 1 (FIG. 2—asymmetrical ends 43) and a machine 2 (FIG. 3—symmetrical ends 43) in order to reduce the noise of electromagnetic origin, whilst providing an optimal performance level imposed by the specifications, in particular the harmonic distortion level (THD) of the electromagnetic force. The process adopted consists of finding the optimal combination of the radius of curvature Rc relative to the rotor radius Rr and of the polar half-angle αp relative to the polar step τ, by varying parameters in the permissible ranges.

By means of a 2-D analysis then 3-D calculations, the parameters r and α were varied in order to obtain an optimal compromise for the values of the aforementioned machines. On the basis of the results indicating the THD of the electromagnetic force (THD of the emf), and the harmonics of order 30 and 40 of the force sustained by each stator tooth (force of interaction between the rotor and the stator which give rise to the noise of the machine) it was possible to determine which were the solutions which succeeded in complying with the THD required, whilst minimising the harmonics 30 and 40 (Fy 30, Fy 40) of the component and the force on each stator tooth.

On the basis of these results, it was possible to determine the optimal ranges of values, i.e. a ratio r between the radius of curvature Rc and the rotor radius Rr contained between 0.52 and 0.63, and a ratio α between the polar half-angle αp and the polar step τ contained between 0.62 and 0.80.

The performance levels can be further improved when the rotor has a ratio between the radius of curvature Rc and the rotor radius contained between 0.54 and 0.61, and a ratio α between the polar half-angle and the polar step contained between 0.64 and 0.78.

Six embodiments will now be presented, i.e. the reference machine (MAR), two machines according to the present invention (machine 1—MA1 and machine 2—MA2), and three comparative machines (MAC1, MAC2 and MAC3). These machines are presented with their characteristics in the following table 1. The comparative machines (MAC1, MAC2 and MAC3) are machines 1 wherein either the ratio r or the ratio α is varied, such that one of these ratios is no longer in the range of the present invention.

TABLE 1

| Characteristics | MAR | MA1 | MA2 | MAC1 | MAC2 | MAC3 |
|---|---|---|---|---|---|---|
| Height [p.u.] | 1 | 1 | 1 | 1 | 1 | 1 |
| αp | 0.61 | 0.76 | 0.78 | 0.78 | 0.76 | 0.56 |
| r [p.u.] | 0.58 | 0.58 | 0.58 | 0.51 | 0.64 | 0.58 |
| Minimal air gap [p.u.] | 1 | 1 | 1 | 1 | 1 | 1 |
| Magnet thickness [p.u.] | 1 | 1 | 1 | 1 | 1 | 1 |

The performance levels of the six machines are then summarised in the following table 2.

TABLE 2

| Characteristics | SPEC | MAR | MA1 | MA2 | MAC1 | MAC2 | MAC3 |
|---|---|---|---|---|---|---|---|
| emf THD | <8% | 6.64 | 7.92 | 6.57 | 8.17 | 7.36 | 5.98 |
| Fy30 [N] | To be | 1 | 0.05 | 0.30 | 1.44 | 1.23 | 1.44 |
| | reduced | | | | | | |
| Fy40 [N] | To be | 1 | 0.69 | 1 | 0.41 | 1.28 | 1.31 |
| | reduced | | | | | | |

Compared with the initial reference machine, the machine 1 has made it possible to reduce the harmonics 30 and 40 of the component and the force acting on each stator tooth, whilst maintaining an emf THD lower than the limit imposed. This makes it possible also to reduce the noise of the machine to a certain level. The machine 2 for its part reduces the harmonic F₃₀ significantly compared with that of the reference machine. Its harmonic F₄₀ remains at a level which is equivalent to that of the reference machine. Consequently, this machine has less noise than the reference machine, whilst having more torque.

On the other hand, when the ratio r is lower than 0.52, only the harmonic F₄ is reduced, with the harmonic F₃₀ having increased and the THD exceeding the minimum required (MAC1). When the ratio r is greater than 0.63 or a is lower than 0.62, the THD is well below the specification, but there is no improvement in the noise level; on the contrary.

It will be appreciated that the foregoing description has been provided purely by way of example, and does not limit the scope of the invention, a departure from which would not be constituted by replacing the different elements by any other equivalents.

In addition, the different characteristics, variants, and/or embodiments of the invention can be associated with one another according to different combinations, provided that they are not incompatible or mutually exclusive.

1. A rotor for an electrical machine for a motor vehicle, the rotor comprising:
an axis of rotation;
a rotor radius;
a polar step;
a body comprising a plurality of rotor teeth defining cavities in which permanent magnets are accommodated, each rotor tooth comprising a single lip for radial retention of a permanent magnet; and
an assembly of magnetic poles, each pole having a curvature in the form of an arc of a circle, the arc of a circle being defined by a radius of curvature, a centre of curvature, and a polar angle,
wherein a ratio between the radius of curvature and the rotor radius is between 0.52 and 0.63, and a ratio between the polar half-angle and the polar step is between 0.62 and 0.80.

2. The rotor according to claim 1, wherein the ratio between the radius of curvature and the rotor radius is contained between 0.54 and 0.61, and the ratio between the polar half-angle and the polar step is contained between 0.64 and 0.78.

3. The rotor according to claim 1, wherein each rotor tooth comprises a radially outer surface, the surface being defined by the said arc of a circle with a centre and two ends, with one of the two ends comprising the lip.

4. The rotor according to claim 3, wherein the two ends of a surface have a curvature different from the curvature of the are of a circle with a centre of this same surface.

5. The rotor according to claim 4, wherein two ends of a single surface are asymmetrical.

6. The rotor according to claim 1, wherein the rotor is of the type with concentration of flux.

7. The rotor according to claim 1, further comprising added-on strips which are each fitted between a lip and an outer periphery of a corresponding permanent magnet.

8. The rotor according to claim 1, wherein the permanent magnets are made of rare earth.

9. The rotor according to claim 1, further comprising: a core provided with a central opening for the passage of a shaft, the rotor teeth being connected to the core by one end.

10. A rotary electrical machine, comprising: a rotor as claimed in claim 1.
